(19) United States
(12) Patent Application Publication
(10) Pub. No.: US 2018/0258321 A1
(43) Pub. Date: Sep. 13, 2018

(54) TEXTILE SLEEVE HAVING A LOW MELT ADHESIVE COATING WITH PROTECTIVE LAYER THEREOVER AND METHOD OF CONSTRUCTION THEREOF

(71) Applicant: Federal-Mogul Powertrain, LLC, Southfield, MI (US)

(72) Inventors: Wenhua Huo, Kanagawa (JP); Shozo Fukuyama, Tokyo (JP)

(21) Appl. No.: 15/457,085

(22) Filed: Mar. 13, 2017

(51) Int. Cl. C09J 7/04; C09J 5/06

(52) U.S. Cl. CPC C09J 7/043; C09J 5/06

(57) ABSTRACT

A protective textile sleeve for providing protection to an elongate member contained therein and method of construction thereof is provided. The sleeve has a wrappable wall including a heat-activatable adhesive disposed thereon. A UV cured layer is disposed over the heat-activatable adhesive to sandwich the heat-activatable adhesive between the wall and the UV cured layer. The UV cured layer prevents the underlying heat-activatable adhesive from adhering to another surface until a suitable heat source activates the heat-activatable adhesive.

### BACKGROUND OF THE INVENTION

### 1. Technical Field

This invention relates generally to protective textile sleeves for providing protection to elongate members contained therein, and more particularly to wrappable textile sleeves having an adhesive mechanism for fixing a portion of the sleeve to itself and/or to an elongate member extending therethrough.

### 2. Related Art

Protective textile sleeves for providing protection to elongate members extending therethrough are known. Protective textile sleeves having a wrappable wall with opposite lengthwise extending edges configured to be wrapped into overlapping relation with one another are also known. To facilitate fixing a portion of the sleeve to itself or to an elongate member extending through the sleeve, a separately applied wrapped tape or glue can be used during installation. The use of tape to secure the sleeve in place has various drawbacks, as it is costly from a material and labor standpoint, and it can also prove unsightly if not applied correctly. Further, the externally applied tape must be readily available during installation of the sleeve, otherwise the assembly process can be delayed, and further yet, the tape can become inadvertently damaged or ineffectively applied during assembly, such as by being inadvertently folded on itself or contaminated via dirty surroundings or hands during application, thus, adversely affecting the ability of the tape to reliably fix the sleeve as intended. The application of separately applied glue during assembly is also costly from a material and labor standpoint, and further requires being readily available during assembly of the sleeve, and can further add cost as a result of the need to provide drying time for the glue.

In addition, glue lacks strength at elevated temperatures, and can prove messy in application, thereby leading to further cost associated with damage, repair and the necessary clean-up thereof. In addition to the aforementioned drawbacks, both known mechanisms discussed above can be time consuming in process, which ultimately adds cost to the process.

### SUMMARY OF THE INVENTION

In accordance with one aspect of the invention, a protective textile sleeve for providing protection to an elongate member contained therein and method of construction thereof is provided. The sleeve has a wrappable wall including a heat-activatable adhesive that is inhibited from bonding to itself and other areas of the sleeve until desired. A UV cured layer is disposed over the heat-activatable adhesive to prevent it from adhering to another surface until a suitable heat source is used to activate the heat-activatable adhesive. Accordingly, the sleeve can be shipped and stored without contamination to the heat-activatable adhesive and without concern over the heat-activatable adhesive becoming adhered to other surfaces of the sleeve.

In accordance with another aspect of the invention, the protective textile sleeve is constructed as a wall of interlaced yarn. The wall has opposite sides extending lengthwise between open opposite ends. The wall has outer and inner surfaces, with the inner surface being configured to bound a circumferentially enclosed cavity extending between the open opposite ends. A heat-activatable adhesive coating is bonded to at least a portion of at least one of the outer and inner surfaces. A UV cured, non-adhesive layer is disposed on the heat-activatable adhesive coating to sandwich the heat-activatable adhesive coating between the wall and the UV cured, non-adhesive layer. The UV cured, non-adhesive layer prevents the heat-activatable adhesive coating from adhering to other portions of the wall absent application of a heat source suitable to melt the heat-activatable adhesive coating.

In accordance with another aspect of the invention, the heat-activatable adhesive coating can be bonded to at least a portion of the inner surface of the wall.

In accordance with another aspect of the invention, the heat-activatable adhesive coating can be bonded to the inner surface along at least one of the opposite sides.

In accordance with another aspect of the invention, the heat-activatable adhesive coating can be bonded to extend substantially from one of the opposite ends substantially to the other of the opposite ends.

In accordance with another aspect of the invention, the heat-activatable adhesive coating can be bonded to the inner surface along each of the opposite sides.

In accordance with another aspect of the invention, an intermediate portion of the inner surface, extending between the opposite sides, can be free of the heat-activatable adhesive coating, while the heat-activatable adhesive coating can be bonded to extend along opposite sides of the intermediate region adjacent the opposite sides of the wall. In this sleeve construction, one of the heat-activatable adhesive coatings can be bonded to an outer surface of the elongate member, and the other of the heat-activatable adhesive coatings can be bonded to the outer surface of the wall upon wrapping the wall about the elongate member.

In accordance with another aspect of the invention, the heat-activatable adhesive coating can be bonded to a substantial entirety or entirety of the inner surface.

In accordance with another aspect of the invention, the wall can be heat-set to bias the opposite sides of the wall into overlapping relation with one another.

The protective textile sleeve of claim 1 wherein said heat-activatable adhesive coating is between about 0.2-0.4 mm thick and said UV cured, non-adhesive layer is between about 0.01-0.05 mm thick.

In accordance with another aspect of the invention, a method of constructing a textile protective sleeve is provided. The method includes interlacing yarn to form a wall having an inner surface and an outer surface extending between opposite ends. Further, bonding a heat-activatable adhesive coating to at least a portion of at least one the inner and the outer surfaces. Then, applying a UV curable, non-adhesive layer on the heat-activatable adhesive coating to sandwich said heat-activatable adhesive coating between the wall and the UV cured, non-adhesive layer. Then, curing the UV curable, non-adhesive layer to prevent the heat-activatable adhesive coating from adhering to other portions of the wall absent application of a heat source suitable to melt the heat-activatable adhesive coating.

In accordance with another aspect of the invention, the method can further include bonding the heat-activatable adhesive coating to at least a portion of the inner surface of the wall.

In accordance with another aspect of the invention, the method can further include bonding the heat-activatable adhesive coating to the inner surface along at least one of the opposite sides.

In accordance with another aspect of the invention, the method can further include bonding the heat-activatable adhesive coating to extend substantially from one of the opposite ends substantially to the other of the opposite ends.

In accordance with another aspect of the invention, the method can further include bonding the heat-activatable adhesive coating to the inner surface along each of the opposite sides and leaving an intermediate portion of the inner surface extending between the opposite sides free of the heat-activatable adhesive coating.

In accordance with another aspect of the invention, the method can further include bonding the heat-activatable adhesive coating to a substantial entirety of the inner surface.

In accordance with another aspect of the invention, the method can further include heat-setting the wall to bias the opposite sides into overlapping relation with one another.

In accordance with another aspect of the invention, the method can further include heat-setting the wall to bias the opposite sides into overlapping relation prior to bonding the heat-activatable adhesive coating to the wall.

In accordance with another aspect of the invention, the method can further include applying the heat-activatable adhesive coating having a thickness between about 0.2-0.4 mm and applying the UV cured, non-adhesive layer having a thickness between about 0.01-0.05 mm.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1 is a perspective view of a wrappable protective sleeve shown fixed about an elongate member in accordance with one aspect of the invention;

FIG. 2 is a broken away plan view of a wall of a sleeve constructed in accordance with one aspect of the invention shown in an unwrapped, generally flattened state, with an adhesive layer disposed on an inner surface of the wall and further including a protective layer disposed on the adhesive layer;

FIG. 3 is a cross-sectional view of the sleeve of FIG. 2 shown wrapped about the elongate member;

FIG. 4 is a broken away plan view of a wall of a sleeve constructed in accordance with another aspect of the invention shown in an unwrapped, generally flattened state, with an adhesive layer disposed on an inner surface of the wall and further including a protective layer disposed on the adhesive layer;

FIG. 4A is a side view of the wall of the sleeve of FIG. 4 shown in a flattened state;

FIG. 4B illustrates the sleeve of FIGS. 4 and 4A wrapped about an elongate member to be protected;

FIG. 5A is a view similar to FIG. 4A of a wall of a sleeve constructed in accordance with another aspect of the invention;

FIG. 5B illustrates the sleeve of FIG. 5A wrapped about an elongate member to be protected;

FIG. 6A is a view similar to FIG. 4A of a wall of a sleeve constructed in accordance with another aspect of the invention;

FIG. 6B illustrates the sleeve of FIG. 6A wrapped about an elongate member to be protected; and

FIG. 7 illustrates a process used to construct a sleeve in accordance with another aspect of the disclosure.

### DETAILED DESCRIPTION OF PRESENTLY PREFERRED EMBODIMENTS

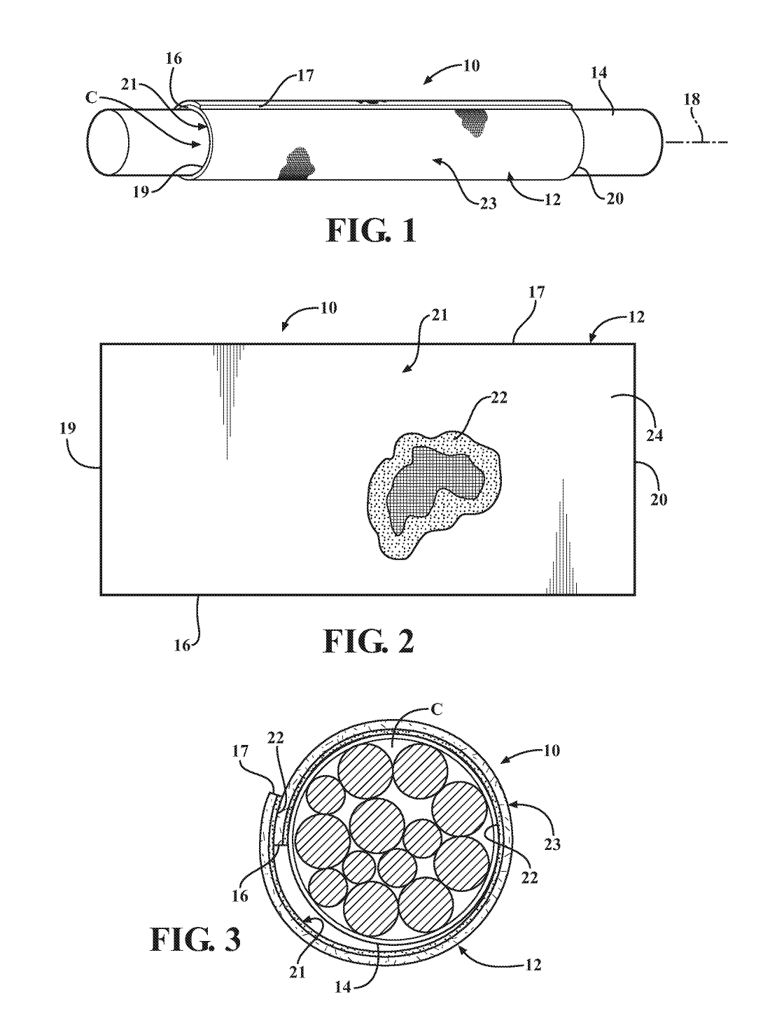

Referring in more detail to the drawings, FIG. 1 illustrates a wrappable textile sleeve constructed in accordance with one aspect of the invention. The sleeve 10 has a wrappable wall 12, such as a wrappable or self-wrapping elongate wall that automatically curls into its wrapped configuration absent some externally applied force, for routing and protecting an elongate member 14, such as a cable, wire harness, or tube, by way of example and without limitation. The elongate wall 12 has opposite inner and outer free sides or side edges, also referred to simply as edges 16, 17, extending generally parallel to a central, longitudinal axis 18 between opposite open ends 19, 20, wherein the edges 16, 17 can be biased into overlapping relation with one another in “cigarette wrapped” fashion, such as via a heat-set, to fully enclose the elongate member(s) 14 within a central cavity C of the sleeve 10. The wall 12 has an innermost face or surface, also referred to as inner surface 21, and an outermost face or surface, also referred to as outer surface 23, wherein the cavity C is defined and bounded by the innermost surface 21 and is readily accessible along the full length of the longitudinal axis 18 via a seam extending between the overlapping edges 16, 17 so that the elongate member(s) 14 can be readily disposed radially into the cavity C, and conversely, removed from the cavity C, such as during service. To adhere and fix the wall 12 to itself to maintain the wall 12 in its closed, wrapped configuration and/or to the elongate member 14 to prevent relative movement between the wall 12 and the elongate member 14, and further, to facilitate preventing end fray of the opposite ends 19, 20, such as during cold cutting in manufacture and also during in use, the wall 12 has a heat-activatable adhesive coating layer, referred to hereafter as adhesive coating 22, bonded to at least a portion of at least one of the innermost surface 21 and the outermost surface 23. The adhesive coating 22 has a first, dried non-adhesive state upon being applied to the wall 12 and subsequently dried, and a second, at least partially melted and bonded adhesive state, also referred to as adhered state, wherein the second adhesive state is activated at a chosen time and location via application of a suitable heat source, thereby causing the adhesive coating 22 to at least partially melt. A curable, non-adhesive protective layer, such as a curable UV non-adhesive layer, referred to hereafter simply as non-adhesive layer 24, is disposed on the heat-activatable adhesive coating 22 to cover and sandwich the heat-activatable adhesive coating 22 between the wall 12 and the curable, non-adhesive layer 24, whereupon the curable non-adhesive layer 24 is then cured, such as via UV light source 26.

The UV cured, non-adhesive layer 24 serves multiple functions, one of which is to prevent the heat-activatable adhesive coating 22 from adhering to other surfaces during manufacture, including other portions of the wall 12, absent application of a heat source suitable to at least partially melt the heat-activatable adhesive coating 22. In addition, the non-adhesive layer 24 facilitates the ability to form the heat-activatable coating 22 with an increased thickness between about 0.2-0.4 mm, and further increases the rate of production of the sleeve 10. This is due in part to the fact that the need to allow for drying time of the heat-activatable coating 22 in production is negated via the presence of the cured non-adhesive layer 24 thereover. Thus, it is to be recognized that the non-adhesive layer 24 can be dispensed on the heat-activatable coating 22 immediately after dispensing the heat-activatable coating 22 onto the wall 12 and prior to the heat-activatable coating 22 being dried or fully dried. Then, the non-adhesive layer 24 can be cured via the UV light source 26 immediately after being dispensed on the underlying heat-activatable coating 22, wherein the curing takes about 1 second or less. With the non-adhesive layer 24 being cured, the heat-activatable coating 22 is fully protected from contamination and from inadvertent bonding to other surfaces, thereby allowing the production rate to be increased without concern over diminishing the integrity of the heat-activatable coating 22 or unwanted bonding thereof to other regions of the wall 12. Accordingly, upon curing the non-adhesive layer 24, the sleeve wall 12 can be allowed to immediately return to its heat-set, curled configuration without concern of unwanted bonding of the adhesive coating 22, including in subsequent shipment and storage. With the cured non-adhesive layer 24 disposed over the heat-activatable coating 22 prior to the coating 22 being dried, not only can the sleeve material continue to be processed without having to wait for the coating 22 to dry, but it is important to note that the heat-activatable coating 22 is still able to dry completely during continued manufacture via radiation cooling and evaporation through the relatively porous textile wall 12. Otherwise, it should be recognized that the wall 12 can be subsequently heat-set, at a temperature low enough to avoid melting the heat-activatable coating 22 but high enough to impart a heat-set in circumferentially extending weft yarns, into a self-wrapping wall upon applying the coating 22 and curing, non-adhesive layer 24, if desired.

Depending on the application needs, the wall 12 can be constructed having any suitable size, including length and diameter. Further, the wall 12 can be formed of interlaced yarn using any desired interlacing process, such as braiding, weaving or knitting. If the wall 12 is formed as a self-wrapping wall, at least some of the weft-wise, circumferentially extending yarn, whether multifilament and/or monofilament, can be provided as any suitable heat-settable polymeric material, such as polyphenylene sulfide (PPS) or polyethyleneterephthalate (PET), for example.

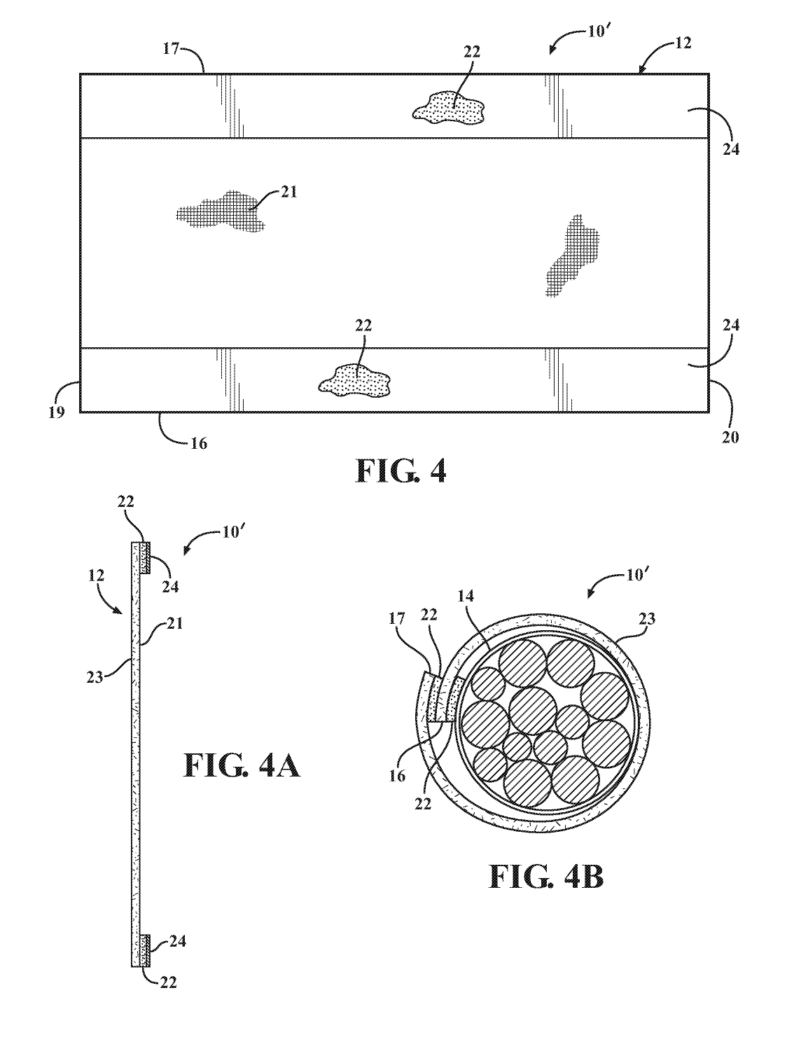

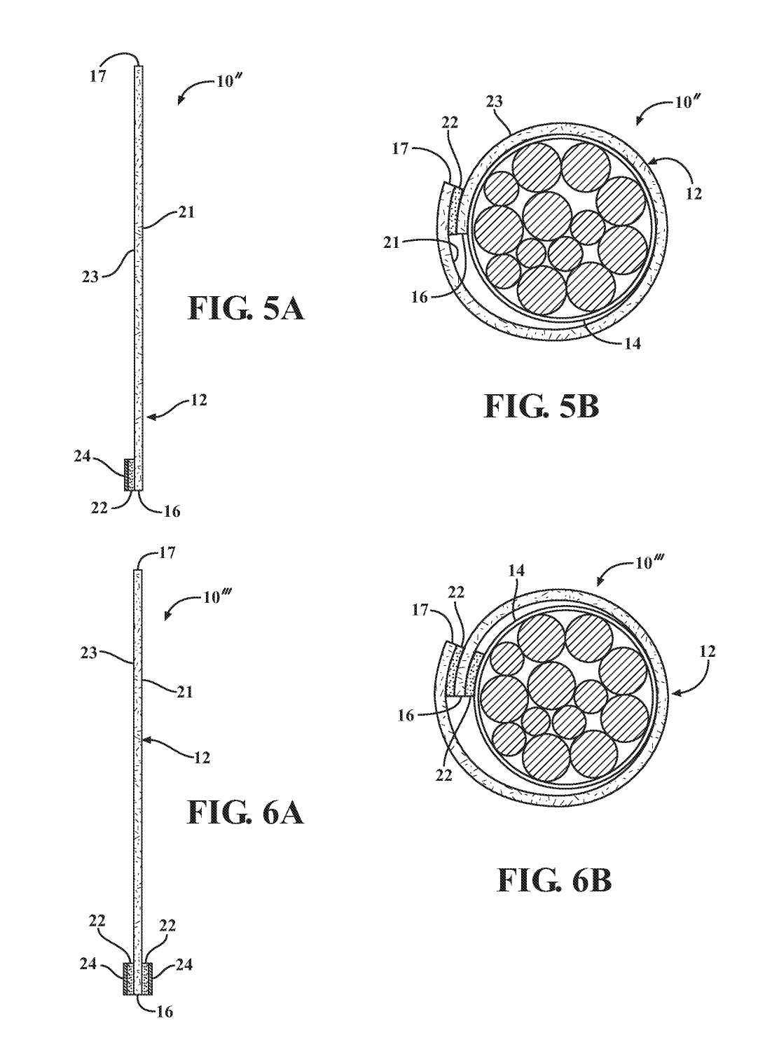

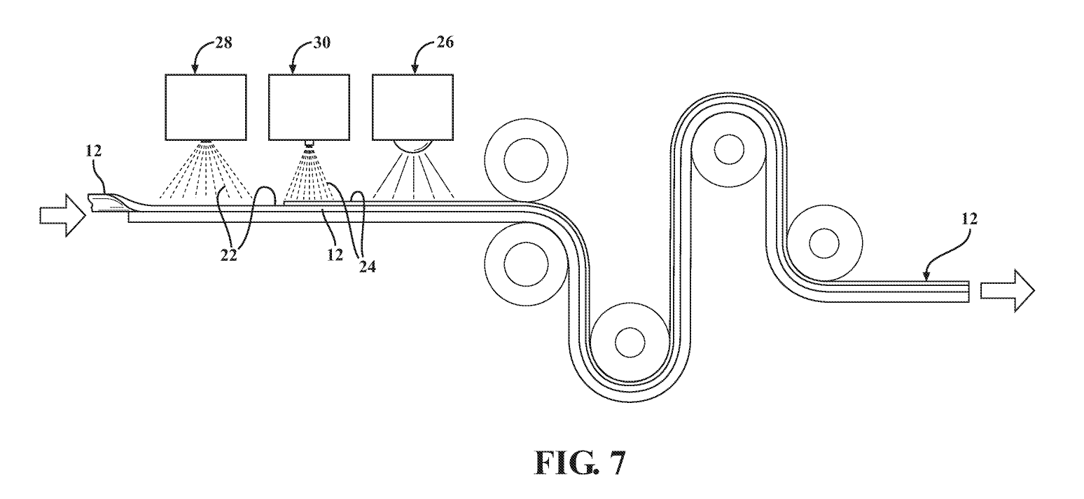

As shown in FIG. 7, in accordance with one aspect of the invention, the wall 12, having already been heat-set into a self-wrapping configuration with the opposite side edges 16, 17 overlapping one another, is opened to a flat or substantially flat shape, whereupon the adhesive coating 22 can be applied as a low viscosity hot melt coating formulation or high viscosity hot melt coating formulation, such as via a spraying, rolling or dipping processes, having a thickness between about 0.2-0.4 mm, by way of example and without limitation, directly on the desired area of the innermost and/or outermost surfaces 21, 23. It is to be recognized that the adhesive coating 22 can be applied to the substantial entirely or the entirety of the inner surface 21 of the wall, as shown in FIGS. 2 and 3, if desired. Further yet, a sleeve 10′ constructed in accordance with another aspect of the invention, as shown in FIGS. 4, 4A and 4B, can have the adhesive coating 22 and overlying cured, non-adhesive layer 24 applied to select regions of the wall 12, such as along and adjacent the inner edge 16 on the inner surface 21 and along and adjacent the outer edge 17 on the inner surface 21, such that the adhesive coating 22 adjacent the inner edge 16 can be bonded to an outer surface of the elongate member 14 and the adhesive coating 22 adjacent the outer edge 17 can be bonded to the outer surface 23 of the wall 12 upon wrapping the wall 12 about the elongate member 14, as shown in FIG. 4B. In yet another embodiment of a sleeve 10″ constructed in accordance with the invention, as shown in FIGS. 5A and 5B, the adhesive coating 22 and overlying cured, non-adhesive layer 24 can be applied solely along and adjacent the inner edge 16 on the outer surface 23, with the remaining portion of the wall 12 remaining free from the adhesive 22, such that upon wrapping the wall 12 about the elongate member 14, as shown in FIG. 5B, the inner surface 21 adjacent the outer edge 17 can be wrapped over the adhesive coating 22 and bonded thereto. Further yet, in another embodiment of a sleeve 10′″ constructed in accordance with the invention, as shown in FIGS. 6A and 6B, the adhesive coating 22 and overlying cured, non-adhesive layer 24 can be applied solely along and adjacent the inner edge 16 on both the inner and outer surfaces 21, 23, with the remaining portion of the wall 12 remaining free from the adhesive 22, such that the adhesive coating 22 on the inner surface 21 can be bonded to the outer surface of the elongate member 14, and upon wrapping the wall 12 about the elongate member 14, as shown in FIG. 6B, the inner surface 21 adjacent the outer edge 17 can be wrapped over the adhesive coating 22 and bonded thereto. Other arrangements of the adhesive coating 22 are contemplated herein, such as discussed in U.S. patent application Ser. No. 14/863,201, filed Sep. 23, 2015, the entire disclosure of which is incorporated herein by way of reference. Regardless of the configuration of the adhesive coating 22, when relative movement between the sleeve 10 and the elongate member 14 is to be prevented, the coating 22 and overlying cured, non-adhesive layer 24 is applied and bonded to at least a portion of the innermost surface 21 that abuts directly against the elongate member 14, thereby providing the ability to bond the adhesive coating 22 to the outer surface of the elongate member 14.

As shown in FIG. 7, after the adhesive coating 22 is applied via a suitable applicator 28 to the desired area(s) of the inner and/or outer surfaces 21, 23, as discussed above, and prior to having to wait for the adhesive coating 22 to become fully dried, the UV curable, non-adhesive layer 24 can be applied via a suitable applicator 30 over the adhesive coating 22, having a thickness between about 0.01-0.05 mm, by way of example and without limitation. Then, the UV curable, non-adhesive layer 24 is subsequently cured via the UV light source 26, wherein the curing occurs within about 1 second or less. The UV light source 26 can be provided having a wave length of about 365 nm, about 250 mJ/cm², and about 200 mm width, by way of example and without limitation. By applying the UV curable, non-adhesive layer 24 over the adhesive coating 22 prior to its being fully dried, the production rate of the wall 12 and sleeve 10 formed therefrom is increased and the cost of scrap is decreased, and thus, the overall cost of manufacture is reduced and the quality of the resulting sleeve 10 is improved. It is to be recognized that the UV curable, non-adhesive layer 24 can be applied over each adhesive coating 22, regardless of the configuration of the adhesive coating 22, thereby sandwiching the adhesive coating(s) 22 between the wall 12 and the overlying UV cured, non-adhesive layer(s) 24. Thus, the underlying adhesive coating 22 is prevented from inadvertently bonding to another surface, such as during manufacture, shipping and storage, such that the adhesive coating 22 only becomes bondable with the desired surface upon application of a suitable heat source to at least partially melt the adhesive coating 22. In addition to the above benefits mentioned, the presence of the UV cured, non-adhesive layer 24 further allows the underlying adhesive coating 22 to be applied having an increased thickness in comparison to that if the layer 24 were not present, which is estimated to be about ¼ to ½ thickness. This is due in part to the protection provided by the non-adhesive layer 24 up until the time comes when the underlying adhesive layer 22 is activated via application of heat.

Many modifications and variations of the present invention are possible in light of the above teachings. It is, therefore, to be understood that the invention may be practiced otherwise than as specifically described, and that the scope of the invention is defined by any ultimately allowed claims. In particular, all features of all claims and of all embodiments can be combined with each other, as long as they do not contradict each other.

What is claimed is:

1. A protective textile sleeve for providing protection to an elongate member contained therein, comprising:
a wall of interlaced yarn, said wall having opposite sides extending lengthwise between open opposite ends, said wall having outer and inner surfaces, said inner surface being configured to bound a circumferentially enclosed cavity extending between said open opposite ends;
a heat-activatable adhesive coating bonded to at least a portion of at least one of said outer surface and said inner surface; and
a UV cured, non-adhesive layer disposed on said heat-activatable adhesive coating to sandwich said heat-activatable adhesive coating between said wall and said UV cured, non-adhesive layer, said UV cured, non-adhesive layer preventing said heat-activatable adhesive coating from adhering to other portions of said wall absent application of a heat source suitable to melt said heat-activatable adhesive coating.

2. The protective textile sleeve of claim 1 wherein said heat-activatable adhesive coating is bonded to at least a portion of said inner surface of said wall.

3. The protective textile sleeve of claim 2 wherein said heat-activatable adhesive coating is bonded to said inner surface along at least one of said opposite sides.

4. The protective textile sleeve of claim 3 wherein said heat-activatable adhesive coating extends substantially from one of said opposite ends substantially to the other of said opposite ends.

5. The protective textile sleeve of claim 3 wherein said heat-activatable adhesive coating is bonded to said inner surface along each of said opposite sides.

6. The protective textile sleeve of claim 5 wherein an intermediate portion of said inner surface, between said opposite sides, is free of said heat-activatable adhesive coating.

7. The protective textile sleeve of claim 5 wherein said heat-activatable adhesive coating is bonded to a substantial entirety of said inner surface.

8. The protective textile sleeve of claim 1 wherein said wall is heat-set with said opposite sides being biased into overlapping relation with one another.

9. The protective textile sleeve of claim 1 wherein said heat-activatable adhesive coating is between about 0.2-0.4 mm thick and said UV cured, non-adhesive layer is between about 0.01-0.05 mm thick.

10. A method of constructing a textile protective sleeve, including:
interlacing yarn to form a wall having an inner surface and an outer surface extending between opposite ends;
bonding a heat-activatable adhesive coating to at least a portion of at least one said inner and said outer surfaces;
applying a UV curable, non-adhesive layer on said heat-activatable adhesive coating to sandwich said heat-activatable adhesive coating between said wall and said UV cured, non-adhesive layer; and
curing said UV curable, non-adhesive layer to prevent said heat-activatable adhesive coating from adhering to other portions of said wall absent application of a heat source suitable to melt said heat-activatable adhesive coating.

11. The method of claim 10, further including bonding said heat-activatable adhesive coating to at least a portion of said inner surface of said wall.

12. The method of claim 11, further including bonding said heat-activatable adhesive coating to said inner surface along at least one of said opposite sides.

13. The method of claim 12, further including bonding said heat-activatable adhesive coating to extend substantially from one of said opposite ends substantially to the other of said opposite ends.

14. The method of claim 12, further including bonding said heat-activatable adhesive coating to said inner surface along each of said opposite sides.

15. The method of claim 14, further including leaving an intermediate portion of said inner surface extending between said opposite sides free of said heat-activatable adhesive coating.

16. The method of claim 14, further including bonding said heat-activatable adhesive coating to a substantial entirety of said inner surface.

17. The method of claim 10, further including heat-setting said wall to bias said opposite sides into overlapping relation with one another.

18. The method of claim 17, further including heat-setting said wall prior to bonding said heat-activatable adhesive coating to said wall.

19. The method of claim 10, further including applying said heat-activatable adhesive coating having a thickness between about 0.2-0.4 mm and applying said UV cured, non-adhesive layer having a thickness between about 0.01-0.05 mm.

20. A protective textile sleeve for providing protection to an elongate member contained therein, consisting of:
a wall of interlaced yarn, said wall having opposite sides extending lengthwise between opposite ends, said wall having outer and inner surfaces, said inner surface being configured to bound a circumferentially enclosed cavity extending between open opposite ends;
a heat-activatable adhesive coating bonded to at least a portion of at least one of said outer surface and said inner surface; and
a UV cured, non-adhesive layer disposed on said heat-activatable adhesive coating to sandwich said heat-activatable adhesive coating between said wall and said UV cured, non-adhesive layer, said UV cured, non-adhesive layer preventing said heat-activatable adhesive coating from adhering to other portions of said wall absent application of a heat source suitable to melt said heat-activatable adhesive coating.
